(19) United States
(12) Patent Application Publication
(10) Pub. No.: US 2025/0325442 A1
(43) Pub. Date: Oct. 23, 2025

(54) MASSAGE DEVICE

(71) Applicant: Dongguan Hongxiang Electronic Technology Co., Ltd., Dongguan (CN)

(72) Inventors: Qinduo Wang, Heyuan (CN); Yinyuan Li, Dongguan (CN); Dongjun Wu, Dongguan (CN)

(21) Appl. No.: 19/183,908

(22) Filed: Apr. 20, 2025

Related U.S. Application Data
(63) Continuation-in-part of application No. 19/014,259, filed on Jan. 9, 2025.
Application No. 19/014,259 is a continuation-in-part of application No. 18/642,854, filed on Apr. 23, 2024, now Pat. No. 12,213,931.

(30) Foreign Application Priority Data
Apr. 19, 2024 (CN) 202420835778.3
Dec. 27, 2024 (CN) 202423268155.1

(51) Int. Cl. A61H 19/00

(52) U.S. Cl. CPC A61H 19/44; A61H 19/34; A61H 2201/1671; A61H 2201/169

(57) ABSTRACT

A massage device includes a shell, a driving mechanism and a branch massage portion. The shell includes a first section, a second section and a third section connected one after another. The third section is configured as a main massage portion to be inserted into human body in an insertion direction. The driving mechanism is disposed in the shell. The branch massage portion is connected the shell and connected to the driving mechanism in a transmission manner. The driving mechanism is configured to drive the branch massage portion to rotate around a rotation axis. The branch massage portion extends in the insertion direction or in a direction opposite to the insertion direction. The branch massage portion and the third section to provide a kneading and pressing massage effect on the organ of human. Therefore, a better stimulation effects is provided, thereby improving the sexual experience.

### CROSS-REFERENCE TO RELATED APPLICATIONS

This is a continuation-in-part Application of U.S. patent application Ser. No. 19/014,259, filed on Jan. 9, 2025, which is a Continuation in part Application of U.S. patent application Ser. No. 18/642,854, filed on Apr. 23, 2024, which claims the priorities of Chinese Utility Model application Ser. No. 20/242,0202016.X, filed on Jan. 26, 2024, and Chinese Utility Model application Ser. No. 20/242,0687877.1, filed on Apr. 3, 2024, which claims priorities of Chinese Utility Model application Ser. No. 20/242,3268155.1, filed on Dec. 27, 2024, and Chinese Utility Model application Ser. No. 20/242,0835778.3, filed on Apr. 19, 2024, the entire contents of which are hereby incorporated by reference.

### TECHNICAL FIELD

The present application relates to the technical field of massage products, and in particular to a massage device.

### BACKGROUND

In recent years, massage devices are developed to help the users to release their sex pressure. Generally, an existing massage device uses a vibration motor to provide vibration to the user's sensitive areas, such as the female genitalia, the male genitalia and the like, which has poor stimulation effects and is therefore difficult to meet users' needs.

### SUMMARY

An object of the present application is to provide a massage device which can provide better stimulation effects, thereby improving the sexual experience.

In order to achieve the above object, a technical solution of the present application provides a massage device, including:
a shell including a first section, a second section, and a third section connected one after another with the second section being connected between the first section and the third section, and the third section being configured as a main massage portion to be inserted into human body in an insertion direction;
a driving mechanism disposed in the shell; and
a branch massage portion connected to the shell, the branch massage portion being connected to the driving mechanism in a transmission manner, wherein the driving mechanism is configured to drive the branch massage portion to rotate around a rotation axis;
wherein the branch massage portion extends in the insertion direction or in a direction opposite to the insertion direction.

In one of the embodiments, the shell defines a recess portion, the first section, the second section, and the third section cooperatively define the recess portion, and the branch massage portion extends into the recess portion.

In one of the embodiments, the shell of at least one of the first section, the second section, or the third section includes an outer layer and an inner layer, the inner layer is covered by the outer layer, and the outer layer is a soft layer.

In one of the embodiments, a maximum cross-sectional area of the first section and a maximum cross-sectional area the third section are both larger than a maximum cross-sectional area of the second section, thereby forming the recess portion at one side of the second section.

In one of the embodiments, the driving mechanism is disposed in an inner cavity of the first section, the branch massage portion is arranged on a side wall of the first section that forms the recess portion.

In one of the embodiments, the driving mechanism is disposed in an inner cavity of the third section, the branch massage portion is arranged on a side wall of the third section that forms the recess portion.

In one of the embodiments, a distal end of the branch massage portion and an end of the third section away from the second section are connected by a connecting portion, and the connecting portion is made of soft material.

In one of the embodiments, the driving mechanism includes a driving motor and a drive shaft, the drive shaft includes a first shaft body and a second shaft body connected to each other, wherein an end of the first shaft body away from the second shaft body is connected to a motor shaft of the driving motor, at least an end of the second shaft body away from the first shaft body extends into the recess portion, the second shaft body is connected to the branch massage portion in a transmission manner, and the driving motor drives the second shaft body to rotate around the rotation axis, with a longitudinal axis of the second shaft body being at an angle with respect to the rotation axis.

In one of the embodiments, the branch massage portion includes a massage housing connected to the second shaft body.

In one of the embodiments, the branch massage portion further includes a flexible sleeve covering an exterior of the massage housing.

In one of the embodiments, the branch massage portion further includes a first vibration motor installed inside the massage housing;
the massage device further includes a second vibration motor installed in an inner cavity of the third section to drive the third section to move;
the first section and the second section are arranged at an angle, with the first section inclined towards the branch massage portion, a protrusion is formed on a side of the first section facing the branch massage portion, and a third vibration motor is installed in the first section

In one of the embodiments, an angle between the first section and the second section is an acute angle, such that the first section and the second section substantially form an L-shape.

In one of the embodiments, the massage device further includes a control board and a battery installed in the inner cavity of the first section, the control board is electrically connected to the battery, and the control board is electrically connected to the driving motor, the first vibration motor, the second vibration motor, and the third vibration motor.

In one of the embodiments, the branch massage portion is elongated.

In one of the embodiments, a maximum cross-sectional area of the third section is larger than that of the branch massage portion.

In one of the embodiments, the third section servers as a first massage portion and the branch massage portion servers as a second massage portion, and the maximum cross-sectional area of the third section is larger than that of the branch massage portion.

In order to achieve the above object, another technical solution of the present application provides a massage device, including:
a shell including a first section, a second section, and a third section connected each other, the second section is connected between the first section and the third section;
a driving mechanism disposed in the shell; and
a branch massage portion connected to the driving mechanism in a transmission manner, wherein the driving mechanism is configured to drive the branch massage portion to rotate;
wherein the branch massage portion is elongated and extends at least partially along a lateral side of the shell with a gap defined between the branch massage portion and the lateral side of the shell.

In one of the embodiments, the driving mechanism includes a driving motor and a drive shaft, the drive shaft includes a first shaft body and a second shaft body connected to each other, wherein an end of the first shaft body away from the second shaft body is connected to a motor shaft of the driving motor, at least an end of the second shaft body away from the first shaft body extends into the recess portion, the second shaft body is connected to the branch massage portion in a transmission manner, the driving motor drives the second shaft body to rotate around the rotation axis, with a longitudinal axis of the second shaft body being at an angle with respect to the rotation axis.

In one of the embodiments, the shell defines a recess portion, the first section, the second section and the third section cooperatively define the recess portion, and the branch massage portion extends into the recess portion.

In one of the embodiments, the driving mechanism is disposed in an inner cavity of the first section, the branch massage portion is arranged on a side wall of the first section that forms the recess portion, and the branch massage portion is connected to the driving mechanism in a transmission manner.

In one of the embodiments, the driving mechanism is disposed in an inner cavity of the third section, the branch massage portion is arranged on a side wall of the third section that forms the recess portion, and the branch massage portion is connected to the driving mechanism in a transmission manner.

Implementing the embodiments of the present application will have the following beneficial effects:

In the massage device of the present application, the third section and the branch massage portion may massage different portions of body simultaneously. The driving mechanism and the branch massage portion are installed in the shell to form an organic entity with an appropriate and compact arrangement, a small size, and a light weight, making it convenient to use. For example, when massaging an organ of human, the organ of human (such as a male penis or a female clitoris) may be directly placed on the shell with the organ of human in contact with the branch massage portion, or the branch massage portion may be inserted into a vagina of woman. Then, the driving mechanism is activated to drive the branch massage portion to perform a circular rotating motion within the recess portion along a preset direction, thereby providing a kneading and pressing massage effect on the organ of human. Therefore, a better stimulation effects is provided, thereby improving the sexual experience. Compared to the prior art, the massage device of this solution may achieve automatic massage operations on the organ of human without increasing the user's burden and fatigue, offering good massage effects and user experience.

### BRIEF DESCRIPTION OF THE DRAWINGS

In order to illustrate the technical solution in embodiments of the present application more clearly, the following briefly introduces accompanying drawings used in the description of the embodiments. Obviously, the accompanying drawings in the following description are only some embodiments of the present application. Those of ordinary skill in the art can obtain other accompanying drawings from these accompanying drawings without any creative efforts.

FIG. 1 is an isometric view of a massage device according to a first embodiment of the present application.

FIG. 2 is a top plan view of the massage device of FIG. 1.

FIG. 3 is a cross sectional view of the massage device taken along line A-A of FIG. 2.

FIG. 4 is an isometric view of a massage device according to a second embodiment of the present application.

FIG. 5 is a top plan view of the massage device of FIG. 4.

FIG. 6 is a cross sectional view of the massage device taken along line B-B of FIG. 5.

FIG. 7 is an isometric view of a massage device according to a third embodiment of the present application.

FIG. 8 is a top plan view of the massage device of FIG. 7.

FIG. 9 is a cross sectional view of the massage device taken along line C-C of FIG. 8.

FIG. 10 is a front plan view of a massage device according to a fourth embodiment of the present application.

FIG. 11 is a schematic, assembled view of a massage device according to a fifth embodiment of the present application.

FIG. 12 is a top plan view of the massage device of FIG. 11.

FIG. 13 is a cross sectional view of the massage device taken along line D-D of FIG. 12.

FIG. 14 a schematic, exploded view of the massage device of FIG. 11.

FIG. 15 is a schematic view of a second massage portion and its driving mechanism of the massage device.

FIG. 16 is an exploded view of FIG. 15.

FIG. 17 is an exploded view of FIG. 15 shown from another aspect.

FIG. 18 is a top plan view of FIG. 15.

FIG. 19 is a further exploded view of a gearbox of the driving mechanism of FIG. 15.

FIG. 20 is a schematic view of a first intermediate state of the second massage portion.

FIG. 21 is a schematic view of a second intermediate state of the second massage portion.

FIG. 22 is a schematic view of a third intermediate state of the second massage portion.

FIG. 23 is a schematic view of trajectory of the second massage portion.

FIG. 24 is a schematic, assembled view of a massage device according to a sixth embodiment of the present application.

FIG. 25 is a cross sectional view of the massage device of FIG. 24.

FIG. 26 is a schematic view of a third driving mechanism of the massage device of FIG. 25.

FIG. 27 is an exploded view of the third driving mechanism of FIG. 26.

FIG. 28 is a schematic, assembled view of a massage device according to a seventh embodiment of the present application.

FIG. 29 is a schematic, assembled view of a massage device according to an eighth embodiment of the present application.

FIG. 30 is a schematic, assembled view of a massage device according to a ninth embodiment of the present application.

FIG. 31 is a cross sectional view of the massage device of FIG. 30.

### DESCRIPTION OF THE EMBODIMENTS

In order to make those skilled in the art better understand the technical solution of the present application, the technical solution in the embodiments of the present application will be clearly and completely described below with reference to accompanying drawings in the embodiments of the present application. Obviously, the described embodiments are only a part of the embodiments of the present application, but not all of the embodiments. Based on the embodiments of the present application, all other embodiments obtained by those skilled in the art without any creative efforts fall within the protection scope of the present application.

It should be noted that when an element is said to be “connected” to another element, it may be directly connected to another element, or indirectly connected to another element through one or multiple intermediate elements.

In the specification, the oriental or positional relationships indicated by the terms “longitudinal”, “transverse”, “top”, “bottom”, “inner”, “outer”, “central”, “axial”, “radial”, “circumferential” and the like are only intended to facilitate the description of the present application and simplify the description based on oriental or positional relationships shown in the accompanying drawings, not to indicate or imply that the apparatus or element referred must have a specific orientation, is constructed and operated in a specific orientation, and therefore cannot be understood as a limitation of the present application.

Unless otherwise specified and limited, the specific meanings of all technical and scientific terms used in the specification can be specifically understood by persons of ordinary skill in the art. The terms used in the specification of this application is for the purpose of describing specific embodiments only and is not intended to limit this application.

### First Embodiment

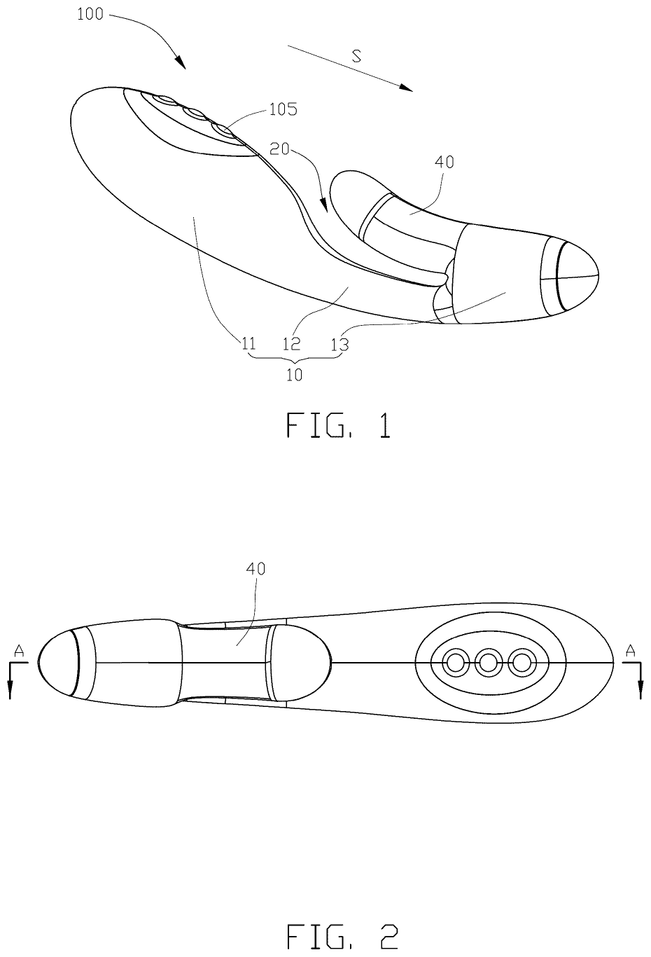

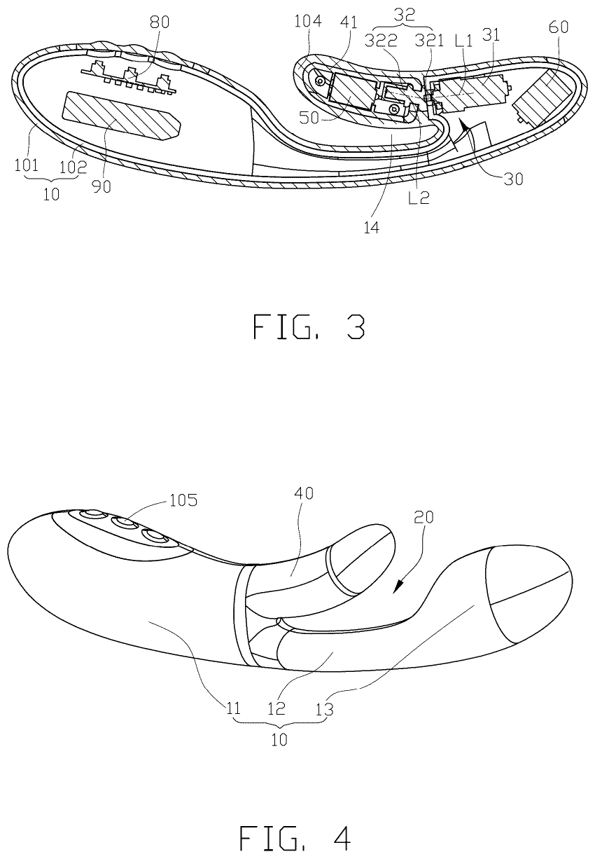

Referring to FIG. 1 to FIG. 3, a massage device 100 according to a first embodiment of the present application is shown. The massage device 100 includes a shell 10 including a first section 11, a second section 12, and a third section 13. The first section 11, the second section 12, and the third section 13 are connected one after another, with the second section 12 connected between the first section 11 and the third section 13. The third section is configured as a main massage portion to be inserted into human body in an insertion direction. The massage device 100 further includes a driving mechanism 30 disposed in the shell 10 and a branch massage portion 40 connected to the shell 10. The branch massage portion 40 is connected to the driving mechanism 30 in a transmission manner. The driving mechanism 30 is configured to drive the branch massage portion 40 to rotate around a rotation axis L1. The branch massage portion extends in the insertion direction or in a direction opposite to the insertion direction. Specifically, the branch massage portion rotates in a circular motion along a preset direction, that is, driven by the driving mechanism 30, the massage portion 40 rotates around the rotation axis L1 to form an annular trajectory.

Implementing the embodiments of the present application will have the following beneficial effects:

In the massage device 100 of the present application, the third section 13 and the branch massage portion 40 may massage different portions of body simultaneously. The driving mechanism 30 and the branch massage portion 40 are installed in the shell 10 to form an organic entity with an appropriate and compact arrangement, a small size, and a light weight, making it convenient to use. For example, when massaging an organ of human, the organ of human (such as a male penis or a female clitoris) may be directly placed on the shell 10 with the organ of human in contact with the branch massage portion 40, or the branch massage portion 40 may be inserted into a vagina of woman. Then, the driving mechanism 30 is activated to drive the branch massage portion 40 to perform a circular rotating motion along a preset direction, thereby providing a kneading and pressing massage effect on the organ of human. Therefore, a better stimulation effects is provided, thereby improving the sexual experience. Compared to the prior art, the massage device 100 of this solution may achieve automatic massage operations on the organ of human without increasing the user's burden and fatigue, offering good massage effects and user experience.

In this embodiment, the shell 10 defines a recess portion 20. The branch massage portion 40 extends into the recess portion 20. The recess portion 20 provides a necessary space for the branch massage portion 40 to perform circular rotating, allowing for a more compact arrangement of the branch massage portion 40 and the shell 10, thereby reducing the overall size of the massage device 100 and achieving a miniaturized design.

Please referring to FIG. 1 to FIG. 3 again, for ease of holding and using, the shell 10 extends along a first direction essentially parallel to the insertion direction. In this embodiment, the first section 11, the second section 12, and the third section 13 cooperatively define the recess portion 20. This arrangement simplifies the formation of the recess portion 20, eliminating the need for additional processing, reducing manufacturing costs and difficulty, thus making the massage device 100 to have a long and narrow structure, small size, and minimal space occupation.

Specifically, the branch massage portion 40 is an elongated (i.e., the branch massage portion 40 is long and thin) and extends at least partially along a lateral side of the shell 10 with a gap 14 defined between the branch massage portion and the lateral side of the shell 10.

Specifically, a maximum cross-sectional area of the first section 11 and a maximum cross-sectional area of the third section 13 are both larger than that of the second section 12, thereby forming the recess portion 20 at one side of the second section 12. A maximum cross-sectional area of the third section 13 is larger than that of the branch massage portion 40.

For example, the first direction may refer to a length direction of the massage device 100, as indicated by the arrow S in FIG. 1.

To improve comfort, in one embodiment, the shell 10 of at least one of the first section 11, the second section 12, and the third section 13 includes an outer layer 101 and an inner layer 102 with the inner layer 102 covered by the outer layer 101. The outer layer 101 may be a soft layer. For example, the soft layer may be made of soft rubber. Soft rubber provides a gentle contact with the skin, offering a good touch experience and comfort. In this application, the inner layer 102 may be made of metal, plastic, or any other material. Preferably, to achieve a certain structural strength while reducing the overall weight, facilitating lightweight design, and improving user experience, the inner layer 102 is made of plastic.

In this application, the inner layers 102 of the first section 11, the second section 12, and the third section 13 are formed as an integrated structure. The shell 10 of each of the first section 11, the second section 12, and the third section 13 includes the outer layer 101 and the inner layer 102 with the inner layer 102 covered by the outer layer 101. The outer layers 101 of the first section 11, the second section 12, and the third section 13 form an integral structure of a soft layer, ensuring both a holding comfort and massaging comfort.

In one embodiment, the driving mechanism 30 is disposed in an inner cavity of the first section 11, the branch massage portion 40 is arranged on a side wall of the first section 11 that forms the recess portion 20, and the branch massage portion 40 is connected to the driving mechanism 30 in a transmission manner. Alternatively, the driving mechanism 30 may be disposed in an inner cavity of the third section 13, the branch massage portion 40 is arranged on a side wall of the third section 13 that forms the recess portion 20, and the branch massage portion 40 is connected to the driving mechanism 30 in a transmission manner.

This arrangement allows the branch massage portion 40 to extend into the recess portion 20 and utilize an ample space provided by the recess portion 20 to perform circular rotating motions, thereby massaging the organ of human, providing better stimulation effects and improving the sexual experience. It also allows the massage device 100 to take on different product forms to meet the preferences and needs of different consumers.

In this application, the branch massage portion 40 is rotatable clockwise or counterclockwise at a constant or variable speed. An offset angle between the branch massage portion 40 and the rotation axis L1 ranges from 0° to 60°.

Please referring to FIG. 1 to FIG. 3, in another embodiment, the driving mechanism 30 includes a driving motor 31 and a driving shaft 32. The driving shaft 32 includes a first shaft body 321 and a second shaft body 322 connected at an angle. The first shaft body 321 is connected to a motor shaft of the driving motor 31 at an end away from the second shaft body 322, and at least the second shaft body 322 extending into the recess portion 20 at an end away from the first shaft body 321. The second shaft body 322 is connected to the branch massage portion 40 in a transmission manner. The driving motor 31 drives the second shaft body 322 to rotate around the rotation axis L1, with a longitudinal axis of the second shaft body 322 being at an angle with respect to the rotation axis L1.

In this embodiment, the first shaft body 321 and the second shaft body 322 are connected at an angle, and the first shaft body 321 extends along the rotation axis L1. Since the first shaft body 321 and the second shaft body 322 are connected at an angle, the second shaft body 322 is rotatable in a circular motion around a central axis L1 of the first shaft body 321 (i.e., the rotation axis L1). Thus, when the driving motor 31 drives the first shaft body 321 to rotate, the second shaft body 322 drives the branch massage portion 40 to rotate in a circular motion within the recess portion 20, providing a kneading and pressing massage effect on the organ of human. This driving structure and manner are simple, feasible, cost-effective, and highly reliable with good durability.

In one embodiment, the branch massage portion 40 includes a massage housing 41 connected to the second shaft body 322. The second shaft body 322 and the massage housing 41 are rigidly connected, allowing the second shaft body 322 to transmit rotational power to the massage housing 41, thereby driving the entire branch massage portion 40 to rotate.

For example, the connection between the massage housing 41 and the second shaft body 322 can be, but is not limited to, snap-fitting, screw connection, adhesive bonding, or any combination thereof.

Since the branch massage portion 40 needs to contact the organ of human during operation and will generate kneading and pressing forces on the organ of human, to reduce the intensity of these forces on the skin and improve massage comfort, the branch massage portion 40 further includes a flexible sleeve 104 covering the exterior of the massage housing 41 in one embodiment. In one embodiment, the outer layer 101 of the shell 10 and the flexible sleeve 104 may be an integral structure.

For example, the flexible sleeve 104 is made of soft rubber.

In one embodiment, the branch massage portion 40 is finger-shaped.

In addition, the branch massage portion 40 further includes a first vibration motor 50 installed within the massage housing 41. While the branch massage portion 40 provides kneading and pressing massage on the organ of human, the first vibration motor 50 simultaneously outputs vibration forces, combining vibration and kneading effects to enhance the massage effect of the massage device 100.

Similarly, when the organ of human is massaged, the organ also contacts with the outer wall of the third section 13. In one embodiment, the massage device 100 further includes a second vibration motor 60, which is installed in the inner cavity of the third section 13. The vibration force generated by the second vibration motor 60 is transmitted to the organ of human, which can also enhance the massage effect.

It is easy to understand that, in actual use, the first vibration motor 50 and the second vibration motor 60 may be activated individually, or may be activated simultaneously, depending on the actual needs.

In one embodiment, the massage device 100 further includes a control board 80 and a battery 90. The control board 80 and the battery 90 are installed in the inner cavity of the first section 11. The control board 80 is electrically connected to the battery 90, and the control board 80 is electrically connected to the driving motor 31, the first vibration motor 50, and the second vibration motor 60. The battery 90 supplies power to the control board 80, which in turn supplies power to the driving motor 31, the first vibration motor 50, and the second vibration motor 60. The control board 80 may control the start/stop and output power of the driving motor 31, the first vibration motor 50, etc., thereby regulating the massage speed of the branch massage portion 40 to meet the different massage needs of various users.

In one embodiment, the massage device 100 further includes a plurality of buttons 105. These buttons 105 are located on the outer side of the shell 10 and are electrically connected to the control board 80. The massage device 100 may be controlled through the buttons 105. Specifically, in this embodiment, the buttons 105 are positioned on the first section 11.

### Second Embodiment

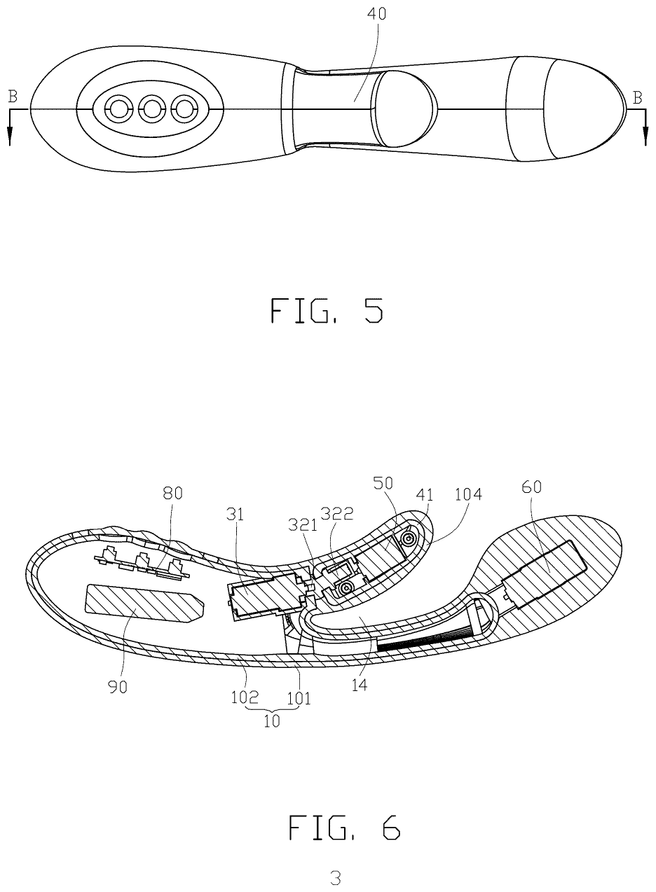

The massage device according to the second embodiment of this application has similar structure as that of the massage device 100 of the first embodiment. FIG. 4 to FIG. 6 show a second embodiment of the massage device of the present application, which differs from the first embodiment mainly in the branch massage portion 40 and the driving motor 31. In the second embodiment, the branch massage portion 40 is disposed on the first section 11 of the shell 10 and is oriented towards the third section 13. Additionally, the driving motor 31 is installed inside the first section 11.

In this embodiment, the third section 13 of the shell 10 includes the outer layer 101 only, that is, the inner layer 102 does not extend to the third section 13. The second vibration motor 60 is directly received in the outer layer 101.

In this embodiment, both the third section 13 and the branch massage portion 40 may be inserted into an organ of human (such as vagina of woman). The third section 13 and the branch massage portion 40 may stimulate the organ of human in different manner, thereby performing different massage effects. Further, the third section 13 and the branch massage portion 40 may also massage different portions of body simultaneously.

The other structural features of the massage device of the second embodiment are similar to those of the first embodiment and will not be repeated here.

### Third Embodiment

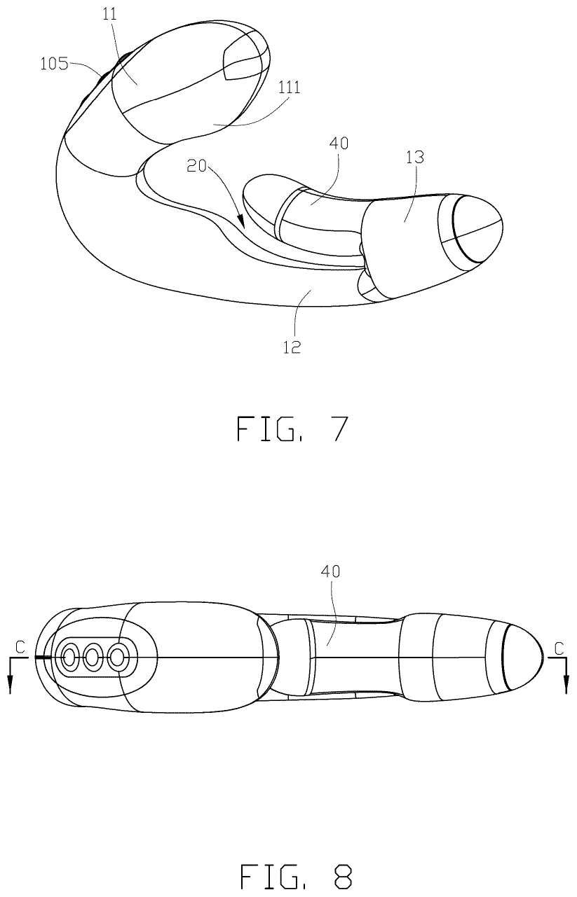

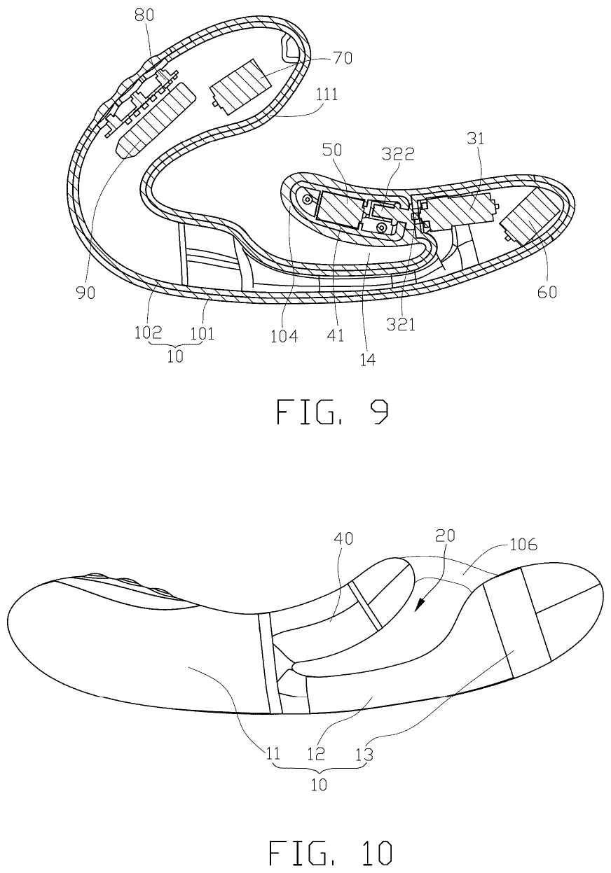

The massage device according to the third embodiment of this application has similar structure as that of the massage device 100 of the first embodiment. FIG. 7 to FIG. 9 show a third embodiment of the massage device of the present application, which differs from the first embodiment mainly in the first section 11. In the third embodiment, the first section 11 is arranged at an angle to the second section 12, and the first section 11 is inclined towards the branch massage portion 40. A protrusion 111 is formed on a side of the first section 11 facing the branch massage portion 40, and a third vibration motor 70 is installed in the first section 11.

By inclining the first section 11 towards the branch massage portion 40, the protrusion 111 can come into contact with the human body. Subsequently, by activating the third vibration motor 70, the vibration force may be transmitted to the human body, thereby achieving a vibrating massage effect.

In one of the embodiments, the angle defined between the first section 11 and the second section 12 is preferably an acute angle, so that the first section 11 and the second section 12 substantially form an L-shape.

In this embodiment, the control board 80 is electrically connected to the third vibration motor 70. The battery 90 supplies power to the control board 80, which in turn supplies power to the third vibration motor 70.

It is easy to understand that, in actual use, the first vibration motor 50, the second vibration motor 60, and the third vibration motor 70 may be activated individually, or any two or more may be activated simultaneously, depending on the actual needs.

The other structural features of the massage device of the third embodiment are similar to those of the first embodiment and will not be repeated here.

### Fourth Embodiment

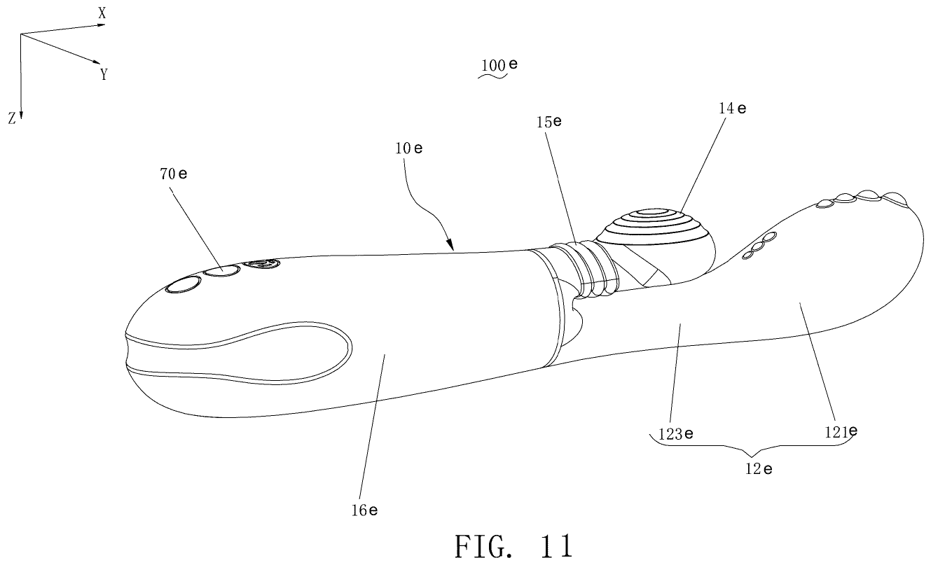

The massage device according to the fourth embodiment of this application has similar structure as that of the massage device 100 of the second embodiment. FIG. 10 shows a fourth embodiment of the massage device of the present application, which differs from the second embodiment mainly in a connecting portion 106. In the fourth embodiment, a distal end of the branch massage portion 40 and an end of the third section 13 away from the second section 12 are connected by the connecting portion 106. Specifically, the connecting portion 106 is made of soft material such as soft rubber.

It is understood that, a distal end of the branch massage portion 40 and an end of the first section 11 away from the second section 12 may be connected by a connecting portion.

The other structural features of the massage device of the fourth embodiment are similar to those of the second embodiment and will not be repeated here.

### Fifth to Eighth Embodiment

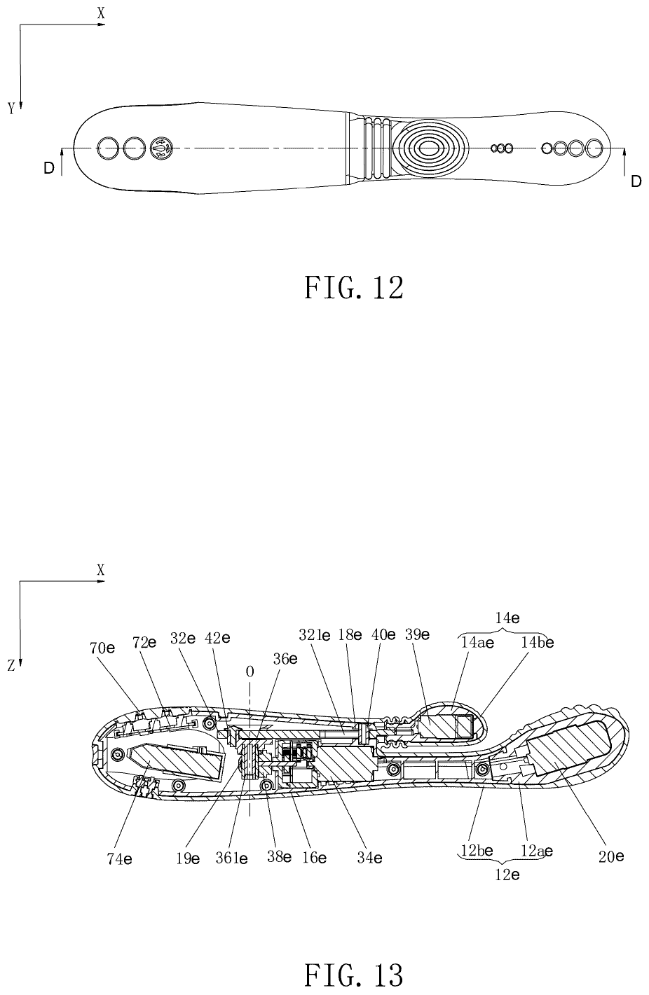

Referring to FIGS. 11-14, a massage device according to an embodiment of the present application is shown. In this embodiment, the massage device 100e includes a shell 10e being provided with a first massage portion 12e and a second massage portion 14e, a first driving mechanism 20e mounted in the shell 10e for driving the first massage portion 12e, and a second driving mechanism 30e mounted in the shell 10e for driving the second massage portion 14e. The massage device 100e of this application includes two massage portions 12e, 14e, which are respectively driven by two driving mechanisms 20e, 30e, and thus can simultaneously stimulate two parts of the human body. A stimulation area of this massage device 100e is thus enlarged and accordingly a stimulation effect is better.

In an embodiment, the shell 10e is generally elongated and rod-shaped, and further includes a shell body 16e. The first and second massage portions 12e, 14e extend outwardly from the shell body 16e along a first direction, such as a longitudinal direction of the shell 10e (i.e., X-direction in the drawings), respectively. In the X-direction, the first massage portion 12e has a length greater than that of the second massage portion 14e, causing a distal part of the first massage portion 12e to extend beyond the second massage portion 14e. In a second direction, such as a lateral direction of shell 10e (i.e., Z-direction in the drawings), the second massage portion 14e and the first massage portion 12e are spaced from each other, so as to ensure that their movements do not interfere with each other and finally not affect the stimulation effect.

During use, the first massage portion 12e and second massage portion 14e of the shell 10e may be inserted into the human body, such as inserted into the vagina, the rectum, and etc. When the massage device 100e is used by a male user, the first massage portion 12e may enhance the stimulation to the prostate. When the massage device 100e is used by a female user, the second massage portion 14e may enhance the stimulation to the clitoris.

In an embodiment, the first massage portion 12e includes a front end section 121e and a connecting section 123e connected between the front end section 121e and the shell body 16e. In the X-direction, the front end section 121e extends beyond the second massage portion 14e, that is, the front end section 121e is staggered from the second massage portion 14e. In the Z-direction, the second massage portion 14e and the transition section 123e are arranged side by side. Preferably, in the lateral direction of the shell 10e, a size of the connecting section 123e of the first massage portion 12e is smaller than a size of the front end section 121e, thereby forming an avoidance space for the setting of the second massage portion 14e. Preferably, the maximum of the overall lateral size of the second massage portion 14e and the connecting section 123e of the first massage portion 12e is substantially the same as the maximum lateral size of the front end section 121e, so that the setting of the second massage portion 14e will generally not increase the overall lateral size of the shell 10e.

The first driving mechanism 20e is set in the first massage portion 12e, particularly in the front end section 121e, for driving the first massage portion 12e to move in the first manner.

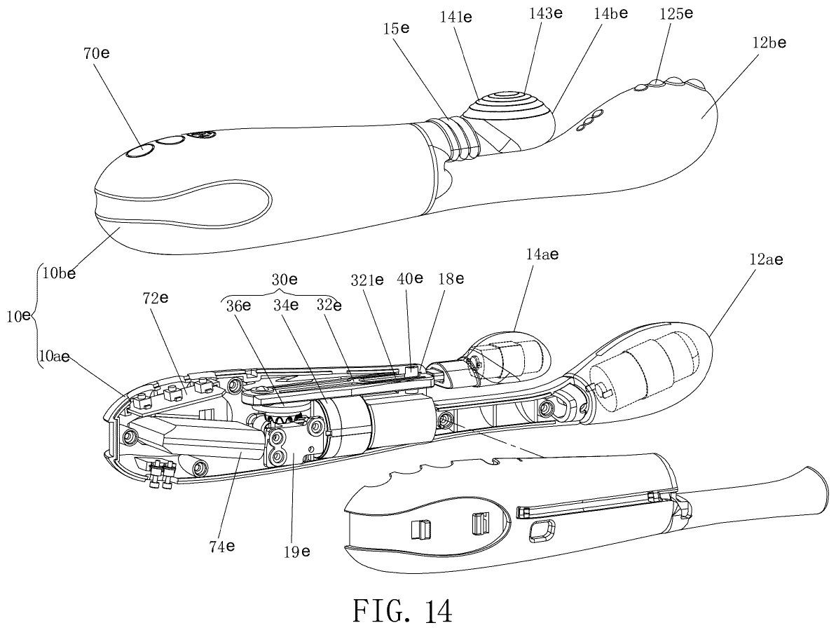

In an embodiment, as shown in FIGS. 13-14, the first driving mechanism 20e is a first vibration motor. When the first driving mechanism 20e is activated, it drives the first massage portion 12e to vibrate at a certain frequency, stimulating the human body, such as the vagina or the rectum through vibration. It should be understood that during use, the vibration frequency of the first driving mechanism 20e may be adjusted according to the user's needs.

In an embodiment, the second driving mechanism 30e includes a swing arm 32e. The swing arm 32e is arranged in the shell body 16e with one end thereof connected to the second massage portion 14e, thereby driving the second massage portion 14e to do reciprocating motion. Specifically, the swing arm 32e is slidably connected to the shell 10e by a first shaft 40e, allowing the second massage portion 14e to do linear reciprocating motion relative to the shell 10e. At the same time, the swing arm 32e is rotatably connected to the shell 10e by a second shaft 42e, allowing the second massage portion 14e to do reciprocating swinging relative to the shell 10e. The linear reciprocating motion and reciprocating swinging of the second massage portion 14e are superimposed, finally forming an annular trajectory, such as a circular trajectory, an elliptical trajectory and the like. Thus, the second massage portion 14e is driven to knead the sensitive area of the human body, such as the vaginal wall of the woman, stimulating the crus of clitoris.

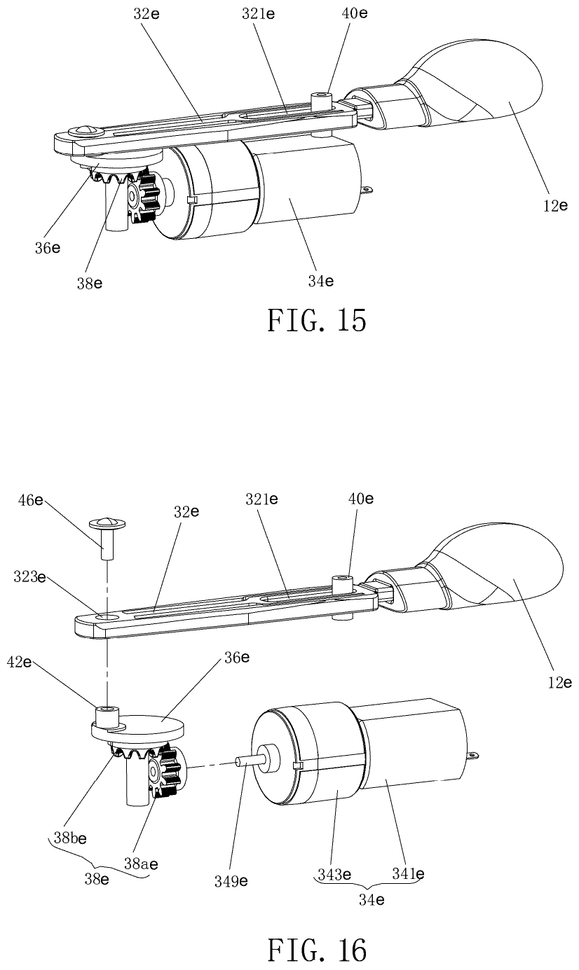

In an embodiment, as shown in FIGS. 15-18, the swing arm 32e is generally an elongated plate with a longitudinal direction thereof being consistent with the X-direction. A middle portion of the swing arm 32e is slidably connected to the shell 10e through the first shaft 40e, and another end of the swing arm 32e is pivotally connected to the shell 10e through the second shaft 42e. The axial direction of the first shaft 40e and the second shaft 42e is basically consistent with the Z-direction and perpendicular to the swing arm 32e. When the second shaft 42e is driven to rotate around an axis O in a longitudinal plane, such as the XY-plane, which is perpendicular to the Z-direction, due to the limitation of the first shaft 40e, the rotational motion of the second shaft 42e is transformed into the linear reciprocating motion of the swing arm 32e in the X-direction and the reciprocating swinging in the XY-plane, finally driving the second massage portion 14e connected to the swing arm 32e to move along a circular trajectory.

In an embodiment, the swing arm 32e is provided with a sliding groove 321e at a portion thereof adjacent to the second massage portion 14e. The sliding groove 321e is elongated and extends along the X-direction. The first shaft 40e is inserted into the sliding groove 321e, with a diameter generally equivalent to a width of the sliding groove 321e but much smaller than a length of the sliding groove 321e. Through the cooperation of the first shaft 40e and the sliding groove 321e, the swing arm 32e can slide relative to the first shaft 40e along its length direction; and the swing arm 32e and the first shaft 40e are relatively fixed in the width direction of the swing arm 32e. In the illustrated embodiment, the shell 10e is provided with a first support seat 18e at a position corresponding to the first shaft 40e, and an end of the first shaft 40e extends beyond the sliding groove 321e and is inserted into the first support seat 18e.

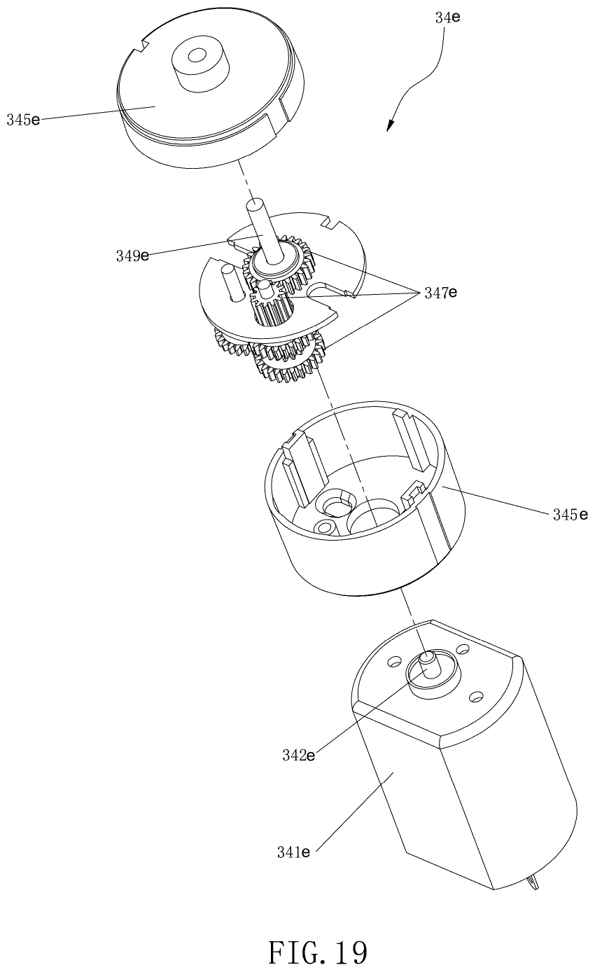

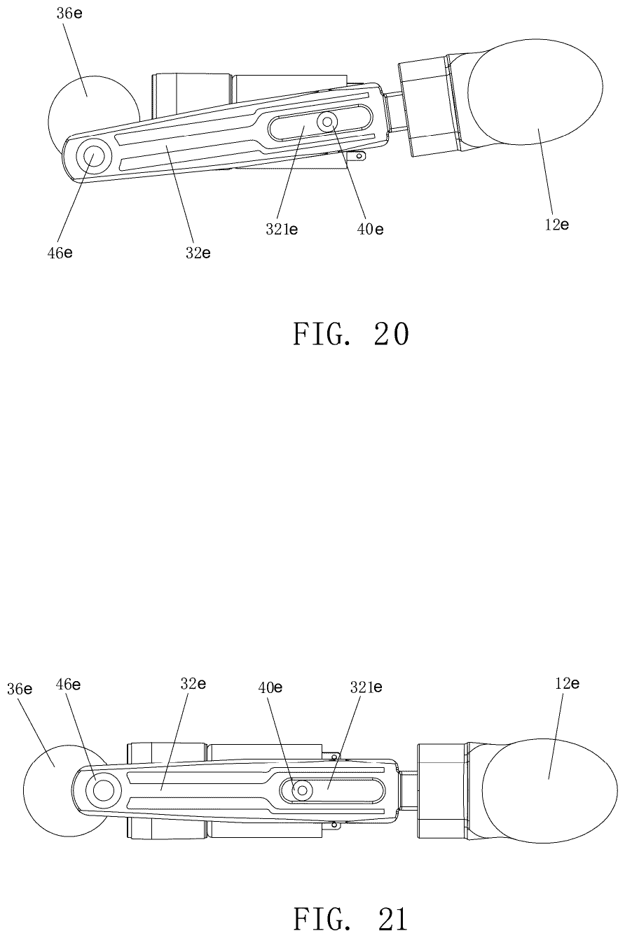

In an embodiment, the second driving mechanism 30e further includes a gearbox 34e and a rotary member 36e connected to the gearbox 34e for power transmission. Referring to FIG. 19, the gearbox 34e includes a motor 341e and a gear unit 343e. The motor 341e serves as a driving component of the massage device 100e and has an output shaft 342e rotating at high-speed. The gear unit 343e includes a gear housing 345e and a plurality of gears 347e arranged in the gear housing 345e. The gears 347e mesh with each other, and a reduction ratio of the whole gear unit 343e can be determined according to the gear ratios between the meshed gears 347e. In an embodiment, the reduction ratio of the gear unit 343e is not less than 4:1 and not more than 100:1, and an output speed of the gearbox 34e is not exceed 1000 rpm. That is, a speed of an output shaft 349e of the gearbox 34e does not exceed 1000 rpm.

The rotary member 36e is connected to the output shaft 349e of the gearbox 34e in a transmission way. Under the driving of the gearbox 34e, the rotary member 36e rotates about the axis O, wherein the axis O may be a central axis of the rotary member 36e. Preferably, a speed of the rotary member 36e does not exceed 1000 rpm. The shell 10e is provided with a second support seat 19e at a position corresponding to the rotary member 36e, and a rotating shaft 361e extends outwardly from the rotary member 36e into the second support seat 19e. Preferably, the rotating shaft 361e is rotatably inserted into the second support seat 19e. The second shaft 42e is eccentrically arranged on the rotary member 36e, and rotates around the axis O under the driving of the gearbox 34e.

In an embodiment, the second shaft 42e and the rotary member 36e may be integrally formed as one piece. The another end of the swing arm 32e, which is away from the second massage portion 14e, is provided with a shaft hole 323e, and the second shaft 42e may be rotatably inserted into the shaft hole 323e. Preferably, a fixing hole 44e is provided in the second shaft 42e, and a rod portion of the fixing member 46e, such as pins, rivets, screws, etc., is inserted into the fixing hole 44e of the second shaft 42e, and a head portion of the fixing member 46e abuts against the swing arm 32e at a periphery of the shaft hole 323e, so as to fix the second shaft 42e and the swing arm 32e in the Z-direction. In this way, the second shaft 42e will not automatically detach from the shaft hole 323e of the swing arm 32e, ensuring the connection stability between the swing arm 32e and the rotary member 36e.

In some embodiments, the second shaft 42e may be integrally formed on the swing arm 32e, and a shaft hole may be formed on the rotary member 36e corresponding to the second shaft 42e. Alternatively, the second shaft 42e may be formed separately and then pivotally connected to the swing arm 32e and/or the rotary member 36e.

When the gearbox 34e is started, the output shaft 342e of the motor 341e rotates at high speed. After being slowed down by the gear unit 343e, the rotary member 36e rotates at an appropriate speed, such as no more than 1000 rpm. The second shaft 42e rotates around the axis O, driving the swing arm 32e to rotate. The swing arm 32e generates displacement in both its length and width directions. Due to the engagement between the first shaft 40e and the sliding groove 321e, the movement of the swing arm 32e in its length direction is not restricted, allowing the swing arm 32e to slide along its sliding groove 321e relative to the first shaft 40e; and the movement of the swing arm 32e in its width direction is limited by the first shaft 40e, causing the swing arm 32e to rotate relative to the second shaft 42e and thus generate swing.

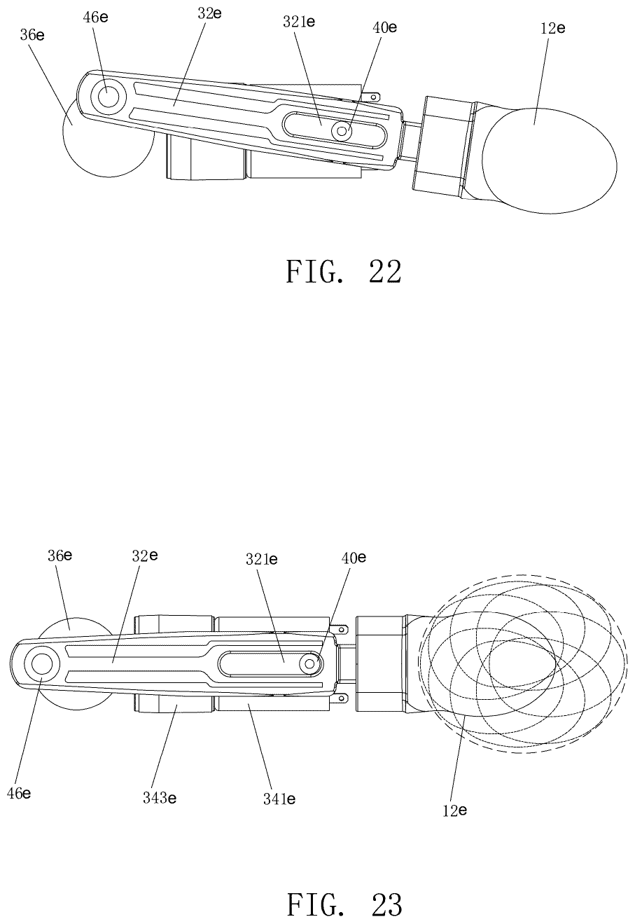

As shown in FIGS. 20-22, as the rotation angle of the second shaft 42e around the axis O changes, the swinging center of the swing arm 32e continuously changes. The swing arm 32e simultaneously generates two different reciprocating movements, namely the linear reciprocating movement of the swing arm 32e in the X-direction and the reciprocating swing of the swing arm 32e in the XY-plane. The combination of these two reciprocating movements drives the second massage portion 14e connected to the swing arm 32e to move along a circular or elliptical trajectory in the XY-plane, as shown by the dashed line in FIG. 23.

Preferably, the length of the swing arm 32e is not less than 2 centimeters, allowing the swing arm 32e and the second massage portion 14e connected to the swing arm 32e to have a larger stroke, thereby an area of the human body kneaded by the second massage portion 14e being enlarged and accordingly a stimulation effect being better. In an embodiment, the trajectory of the second massage portion 14e is substantially an elliptical trajectory, and the major axis of the elliptical trajectory is not less than 1 centimeter. In another embodiment, the trajectory of the second massage portion 14e is substantially a circular trajectory, and the diameter of the circular trajectory is not less than 1 centimeter.

Compared to the existing massage devices which stimulate the human body by hitting in high-frequency, the second massage portion 14e of the present massage device moves along an annular trajectory, and thus kneads the sensitive area of the human body. An area of the human body kneaded by the second massage portion 14e is enlarged and accordingly a stimulation effect is better. Moreover, the second massage portion 14e kneads the human body, which is similar to the motion of the hand, providing a more comfortable sexual experience.

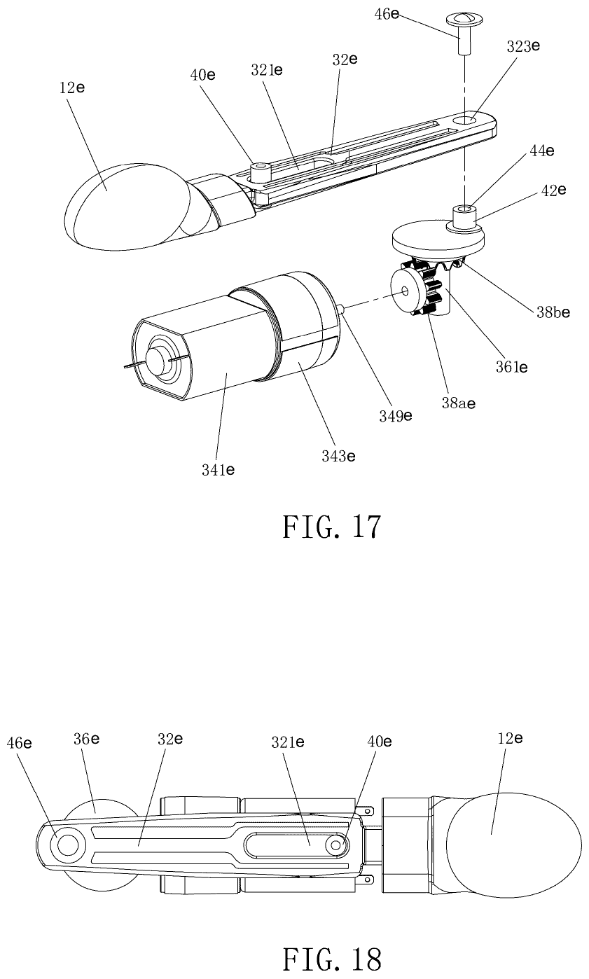

In an embodiment, as shown in FIGS. 16-17, a steering unit 38e is provided between the rotary member 36e and the gearbox 34e. By means of the steering unit 38e, the direction of power transmission may be changed, facilitating the arrangement of the gearbox 34e. In the illustrated embodiment, the gearbox 34e is arranged with its output shaft 349e being generally parallel to the swing arm 32e. The steering unit 38e is located at an axial end of the gearbox 34e and the swing arm 32e. In this way, a space below the swing arm 32e may be utilized to set the gearbox 34e, which is conducive to the miniaturization of the device.

Specifically, the steering unit 38e is a steering gear unit, and includes a plurality of gears that mesh with each other, such as a first gear 38ae, a second gear 38be, and etc. The first gear 38ae is mounted around the output shaft 349e of the gearbox 34e, preferably the first gear 38ae and the gearbox 34e are arranged coaxially. The second gear 38be is mounted around the rotating shaft 361e of the rotary member 36e, preferably the second gear 38be and the rotary member 36e are integrally formed as on piece. The first gear 38ae and the second gear 38be may be bevel gears and mesh with each other, achieving a change of 90 degrees in the direction of power transmission between the gearbox 34e and the rotary member 36e.

In other embodiments, the direction of power transmission can be determined based on the internal space of the massage device 100e, and the angle that needs to be changed is not limited to 90 degrees. Users can choose corresponding type of steering unit according to their needs to achieve direction change, which should not be limited by specific embodiments. In some embodiments, the steering unit 38e may also be integrated inside the gearbox 32e, thereby a separate steering unit is no longer needed. Alternatively, in some embodiments, there is no need for direction change between the gearbox 34e and the rotary member 36e, and thus the steering unit 38e may be omitted.

As shown in FIGS. 13-14, the second driving mechanism 30e may further include a second vibration motor 39e set in the second massage portion 14e. The second massage portion 14e is driven by the gearbox 34e to move in a circular trajectory, and also vibrates at a predetermined frequency under the action of the second vibration motor 39e. In this way, while kneading the stimulated area, the second massage portion 14e may generate deep stimulation on the stimulated area through vibration, generating a dual stimulation effect on the human body, and accordingly having a better stimulation effect.

In an embodiment, the shell body 16e may serve as a handle of the massage device 100e, facilitating holding and operation. The shell body 16e is provided with buttons 70e thereon, which may be touch type buttons and/or mechanical buttons. The shell body 16e is provided with a control circuit board 72e therein, which forms a control circuit with the gearbox 34e, the first vibration motor, the second vibration motor 39e, and etc. The user can control the operation of the massage device 100e through the buttons 70e, including controlling the speed and direction of the gearbox 34e, the vibration frequency of the first vibration motor and the second vibration motor 39e, and etc. A battery 74e, preferably a rechargeable battery, is provided inside the shell body 16e. The battery 74e is connected to the control circuit board 72e electrically and serves as a power source of the massage device 100e.

In an embodiment, as shown in FIGS. 13-14, the shell 10e may be a double-layer structure, and includes an inner shell 10ae and an outer shell 10be enclosing the inner shell 10ae. The inner shell 10ae is made of hard materials such as plastic, metal, etc., which has a relatively high strength and thus provides support for the components mounted inside the shell 10e, such as the first driving mechanism 20e, the second driving mechanism 30e, and etc. The outer shell 10be is made of flexible materials such as silicone, rubber, and etc., and has a soft touch. Preferably, after the inner shell 10ae being assembled with the first driving mechanism 20e, the second driving mechanism 30e, etc., the outer shell 10be is formed on the inner shell 10ae integrally through over-molding, achieving good sealing effect for the components inside the shell 10e. The outer shell 10be plays a waterproof and dustproof role, facilitating the cleaning and storage of the massage device 100e.

As shown in FIG. 13, the first massage portion 12e and the second massage portion 14e are both double-layer structures. The first massage portion 12e includes a first hard layer 12ae and a first soft layer 12be covered on the first hard layer 12ae. The second massage portion 14e includes a second hard layer 14ae and a second soft layer 14be covered on the second hard layer 14ae. The hard layers 12ae, 14a may be part of the inner shell 10ae, while the soft layers 12be, 14be may be part of the outer shell 10be.

The end of the swing arm 32e is inserted into the second hard layer 14ae of the second massage portion 14e, and is fixedly connected to the second hard layer 14ae through snap-fitting, welding, bonding, interference fitting, and etc., so as to drive the entire second massage portion 14e to move. The second hard layer 14ae can better transmit the force of the swing arm 32e to the second massage portion 14e, allowing the second massage portion to have a larger swing and/or movement range, thereby having a larger stimulation range. The second soft layer 14be provides a soft touch and a certain buffer for the second massage portion 14e, making the stimulated area of the human body more comfortable. Preferably, the end of the swing arm 32e can be integrally fixed in the second hard layer 14ae during the process of forming the second soft layer 14be, which not only simplifies production and assembly, but also enhances the connection strength between the second massage portion 14e and the swing arm 32e.

In this embodiment, the second soft layer 14be of the second massage portion 14e is integrally connected to the outer shell 10be corresponding to the shell body 16e, and wrinkles 15e are formed at a joint of the second soft layer 14be and the outer shell 10be. The second hard layer 14ae of the second massage portion 14e is disconnected from the inner shell 10ae at a position corresponding to the wrinkles 15e, making the second massage portion 14e be easier to deform during movement for the wrinkles 15e at the joint of the second massage portion 14e and the outer shell 10be. The second massage portion 14e thus may have a larger swing and/or movement amplitude, thereby having a larger stimulation range.

In this embodiment, an outer, lateral surface of the second massage portion 14e away from the first massage portion 12e, such as the upper surface of the second massage portion 14e in FIGS. 11-14, serves as a massage surface 141e of the second massage portion 14e, for kneading the stimulated area that is in contact with it. When in use, unlike the point-to-point hitting of existing massage devices, the second massage portion 14e always maintains surface contact with the stimulated area, such as the vaginal wall, the rectum wall, and etc., and a contact position is constantly changing, achieving the effect of kneading. Preferably, the massage surface 141e of the second massage portion 14e is a convex surface, which can better interact with the stimulated area.

In the embodiments shown in FIGS. 11-14, there are protrusions 125e provided on an outer surface of the first massage portion 12e, so as to enhance the stimulation effect to the vaginal wall or the rectum wall. The massage surface 141e of the second massage portion 14e is provided with patterns 143e, such as annular patterns, to enhance the stimulating effect to the vaginal wall or the crus of clitoris. In other embodiments, the outer surface of the first massage portion 12e may have patterns formed thereon, and the massage surface 141e of the second massage portion 14e may have protrusions formed thereon. The protrusions, patterns, and etc. may be formed on the entire outer surface of the first massage portion 12e and/or the second massage portion 14e, or may be formed on a portion of the outer surface of the first massage portion 12e and/or the second massage portion 14e.

It should be understood that under the driving of the first driving mechanism 20e and the second driving mechanism 30e, the first massage portion 12e and the second massage portion 14e themselves can generate sufficient stimulation to the human body.

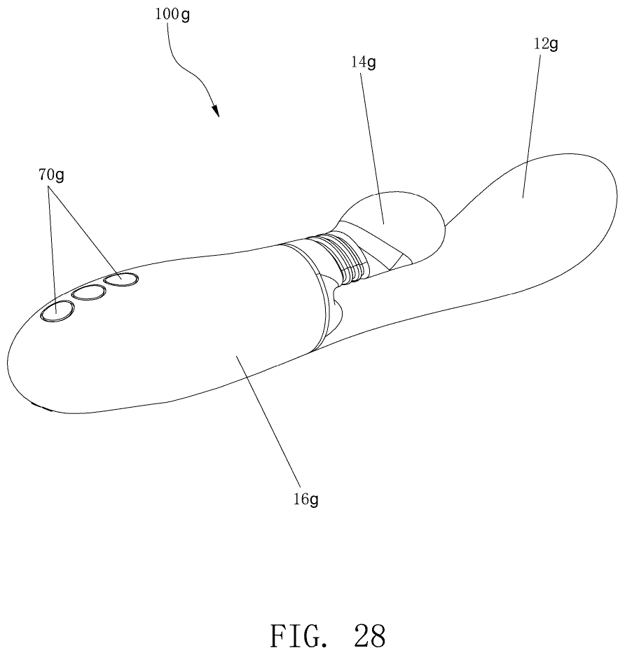

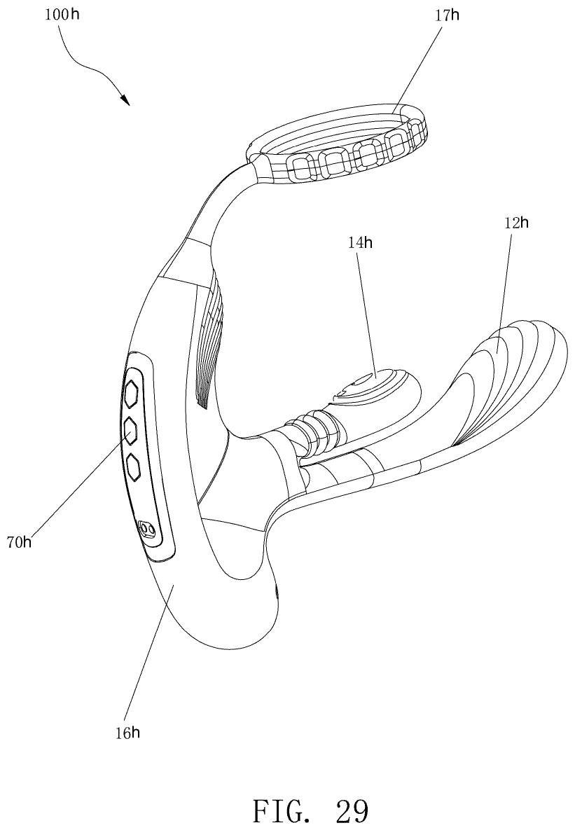

In a seventh embodiment, a massage device 100g includes a shell 10g. The shell 10g having a first massage portion 12g and a second massage portion 14g. The outer surfaces of the first massage portion 12g and/or the second massage portion 14g may be smooth surfaces, as shown in FIG. 28. The shell 10g is generally elongated and rod-shaped, and further includes a shell body 16g. The shell body 16g is provided with buttons 70g thereon, which may be touch type buttons and/or mechanical buttons.

In an eighth embodiment, as shown in FIG. 29, a massage device 100h includes a shell 10h. The shell 10g having a first massage portion 12h and a second massage portion 14h. The shell 10h further includes a shell body 16h. The shell body 16h is provided with buttons 70h thereon, which may be touch type buttons and/or mechanical buttons. An annular ring 17h is provided on the shell body 16h of the massage device 100h. The annular ring 17h may be formed separately and then connected to the shell body 17h, or may be formed integrally with the shell body 17h. The massage device 100e may be fixed onto the human body, such as on the penis or the scrotums, by the annular ring 17h.

In the above embodiment, the entire outer shell 10be of the shell 10e, 10g, 10h is an integrated structure made of flexible materials such as rubber, silicone, and etc., so that the outer layers of the first massage portion 12e, 12g, 12h and the second massage portion 14e, 14g, 14h, namely the soft layers 12be and 14be, have a soft touch, increasing the comfort of use. In other embodiments, the outer layers of the first massage portion 12e, 12g, 12h and the second massage portion 14e, 14g, 14h may be made of other flexible materials that can directly contact the skin, which is not limited in the present application. Furthermore, it should be noted that as long as the outer layers of the first massage portion 12e, 12g, 12h and the second massage portion 14e, 14g, 14h are soft layers, the outer layer of the shell body 16e may be either a soft layer or a hard layer.

During the use of the massage device 100e, the user may activate the first driving mechanism 20e to achieve a stimulation effect to the vagina through the high-frequency vibration of the first massage portion 12e; or, the user may activate the second vibration motor 39e of the second driving mechanism 30e to achieve a stimulation effect to the crus of clitoris through the high-frequency vibration of the second massage portion 14e; or, the user may activate the gearbox 34e of the second driving mechanism 30e to achieve a kneading effect to the crus of clitoris through the movement of the second massage portion 14e; or, the user may simultaneously activate multiple or all of the teeth box 34e, first vibration motor, and second vibration motor 39e to experience a multi-stimulation effect to the vagina and the crus of clitoris, which is convenient in use.

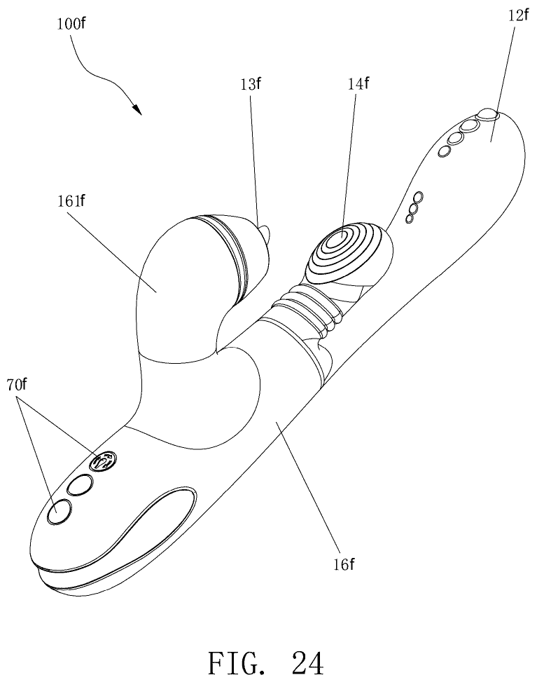

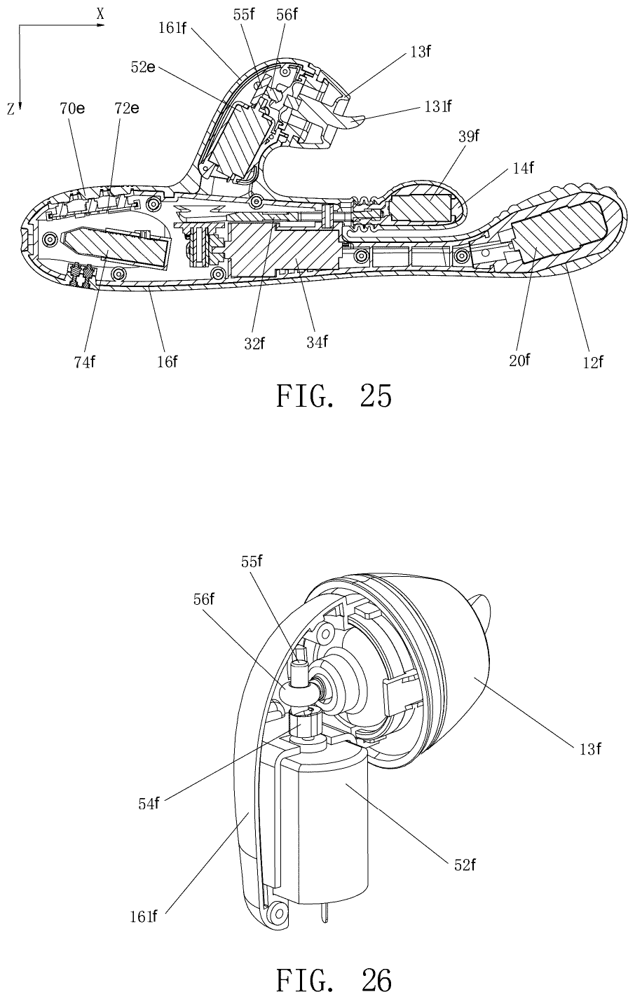

Referring to FIGS. 24-27, a massage device according to a sixth embodiment of the present application is shown. In this embodiment, the massage device 100f includes a shell 10f being provided with a first massage portion 12f, a second massage portion 14f, and a third massage portion 13f, and a first driving mechanism 20f, a second driving mechanism 30f, and a third driving mechanism 50f mounted in the shell 10f. The first driving mechanism 20f is used to drive the first massage portion 12f, the second driving mechanism 30f is used to drive the second massage portion 14f, and the third driving mechanism 50f is used to drive the third massage portion 13f. Among them, the first massage portion 12f, the second massage portion 14f, the first driving mechanism 20f, and the second driving mechanism 30f are generally the same as the forgoing embodiments, and will not be described here.

In this embodiment, a branch 161f extends upwardly and slightly forwardly from the shell body 16f, and the third massage portion 13f is provided at a distal end of the branch 161f. In the X-direction, the third massage portion 13f is not exceed the position of the second massage portion 14f. In the Z-direction, the third massage portion 13f is located above the second massage portion 14f and is separated from the second massage portion with a certain distance, thereby forming a space therebetween to accommodate a part of the human body, such as the vulva of the woman. Preferably, the distance between the third massage portion and the second massage portion 14f is much greater than the distance between the second massage portion 14f and the first massage portion 12f. In this embodiment, the third driving mechanism 50f is arranged in the branch 161f of the shell 10e and connected to the third massage portion 13f in a transmission way.

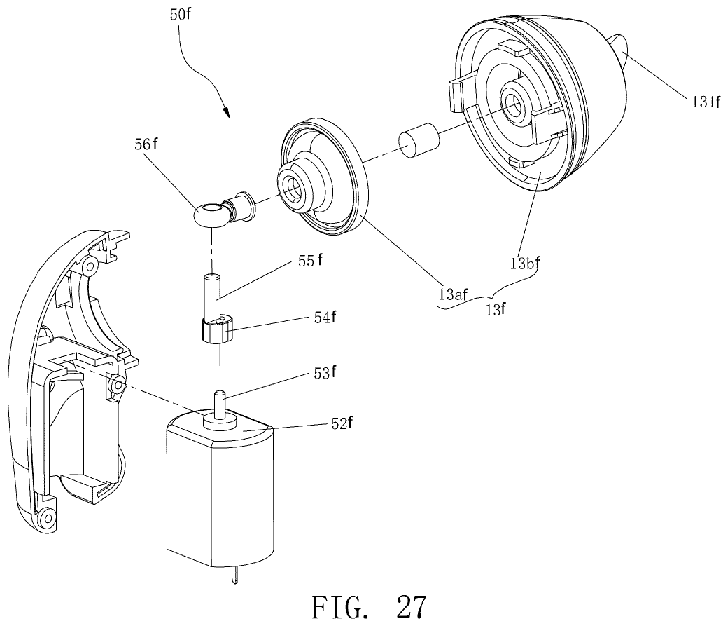

As shown in FIGS. 26-27, the third driving mechanism 50f includes a gearbox 52f, an eccentric wheel 54f driven by the gearbox 52f, and a connecting rod 56f connected between the eccentric wheel 54f and the third massage portion 13f. The eccentric wheel 54f is connected to an output shaft 53f of the gearbox 52f and rotates at an appropriate speed under the driving of the gearbox 52f. The eccentric wheel 54f is provided with a pivot 55f, which is arranged eccentrically relative to a rotary axis of the eccentric wheel 54f, so that the pivot 55f rotates around the rotary axis of the eccentric wheel 54f. One end of the connecting rod 56f is rotatably connected to the pivot 55f, and the other end of the connecting rod 56f is fixedly inserted into the third massage portion 13f, so that the gearbox 52f can drive the third massage portion 13f to swing through the eccentric wheel 54f.

In this embodiment, the third massage portion 13f is a double-layer structure, including a third hard layer 13af and a third soft layer 13bf covered on the third hard layer 13af. The third hard layer 13af may be a part of the inner shell 10af, and the third soft layer 13bf may be a part of the outer shell 10bf. The connecting rod 56f is connected to the third hard layer 13af, wherein the connecting rod 56f and the third hard layer 13af may be tightly fitted. A tongue 131f extends outward from a central portion of the third soft layer 13bf, for licking the vulva of the human body, particularly the clitoris. When the gearbox 52f is started, the pivot 55f rotates around the rotary axis of the eccentric wheel 54f, causing the connecting rod 56f to move back and forth in its axial direction and swing back and forth around the pivot 55f, thereby driving the tongue 131f of the third massage portion 13f to move along a circular trajectory, which may also have a large stimulation range. The massage device 100e of this embodiment includes three massage portions 12f, 14f, and 13f, which are respectively driven by three driving mechanisms 20f, 30f, and 50f. It can simultaneously stimulate three parts of the human body, with a larger stimulation range and better stimulation effect, further improving the user experience.

### Ninth Embodiment

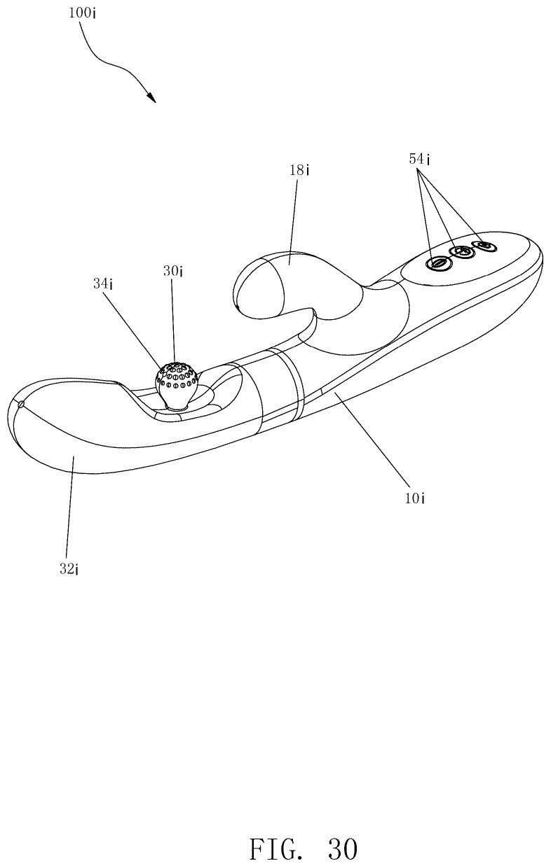

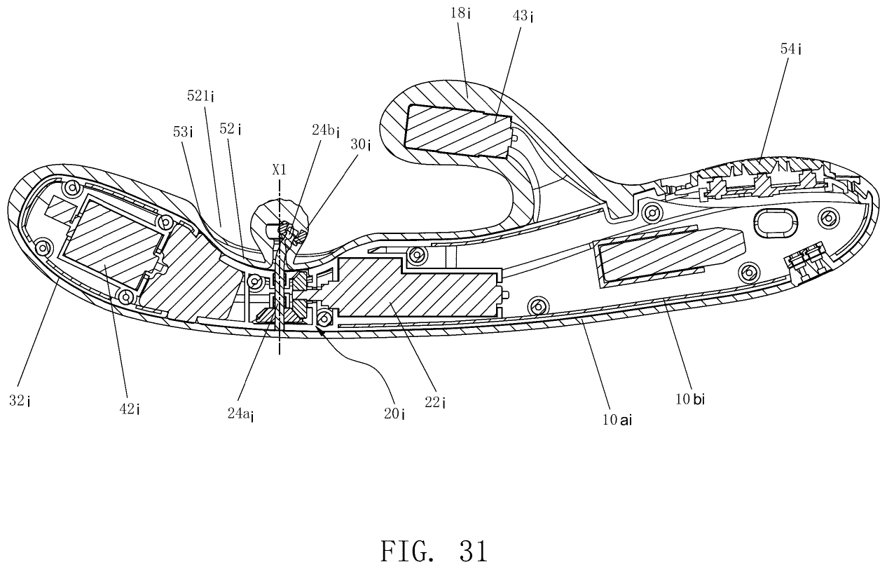

FIGS. 30-31 show a ninth embodiment of the massage device of the present application. In this embodiment, the massage device 100i includes a shell 10i and a driving mechanism 20i arranged in the shell 10i. The shell 10i of the massage device 100i is generally elongated and rod-shape. The shell 10i is provided with a massage portion 30i and a massage end 32i, and the driving mechanism 20i is connected to the massage portion 30i in a transmission way. Under the action of the driving mechanism 20i, the massage portion 30i rotates around a first axis X1 to form an annular trajectory. The massage end 32i is formed at a front end of the shell 10i. A branch 18i extends from the middle portion of the shell 10i curvedly towards an upper side of a front end of the shell 10i, and the massage portion 30i is between the branch 18i and the massage end 32i.

In this embodiment, the shell 10i further includes a holding end, and the holding end is defined on a rear end of the shell 10i thus facilitating to grab the shell 10i. In this embodiment, the massage portion 30i is generally spherical-shaped or ellipsoidal-shaped.

In this embodiment, a base portion 52i is formed on the shell 10i. One end of the massage portion 30i serving as a connecting end is connected to the base portion 52i, and another end of the massage portion 30i serving as a free end. Specifically, the base portion 52i is concaved inwardly recessed to form a bowl-shaped portion which is arranged around the first axis X1, wherein the first axis X1 is generally perpendicular to a longitudinal direction of the shell 10i. The massage portion 30i is set in the base portion 52i, with one end thereof serving as a connecting end for connecting a central, bottom of the base portion 52i. The massage portion 30i extends partly beyond the base portion 52i through an open side 521i of the base portion 52i. When the massage portion 30i is driven to rotate, it swings in the base portion 52i with its connecting end as the center. It should be understood that the base portion 52i may be other shape, such as a protrusion and a column being as high as the holding end. Preferably, protruding dots 34i are provided on an outer surface of the massage portion 30i to enhance the stimulation effect of the massage portion 30i.

In this embodiment, the shell 10i may be a double-layer structure, and includes an outer layer 10ai and an inner layer 10bi inside the outer layer 10ai. The outer layer 10ai is made of soft material, and the inner layer 10bi is made of hard materials such as plastic, metal, etc. The inner layer 10bi provides support for the outer layer 10ai and the driving mechanism 20i. In this embodiment, the massage portion 30i may be a single-layer structure, and includes the outer layer 10ai.

In this embodiment, the outer layer 10ai of the massage portion 30i, the outer layer 10ai of the base portion 52i and outer layer 10ai of the rest of the shell 10i are integrally formed, thus not only simplifying production and assembly of the massage device 100i, but also improving the connection strength between the massage portion 30i and the outer layer 10ai. During rotation of the massage portion 30i around the first axis X1, it can generate greater deformation without damage, further increasing the stimulation force and stimulation range of the massage portion 30i on the human body. In addition, the outer layer 10ai encloses the inner layer 10bi, which can achieve good sealing effect for the components inside the shell 10i, thereby play a waterproof and dustproof role, and facilitating the cleaning and storage of the massage device 100i. For the massage device 100i of the present application, it should be understood that the massage portion 30i and the outer layer 10ai of shell 10i may be formed separately and then assembled together, so that the massage portion 30i can be selectively disassembled and replaced. In practical applications, the massage device 100i can be formed with several massage portions 30i in different shapes and/or sizes. According to specific usage scenarios, the user can choose a corresponding massage portion 30i to ensure the stimulation effect. In this situation, the outer layer 10ai is no longer limited to be formed by the same material as that of the massage portion 30i. Soft materials such as silicone and rubber, as well as hard materials such as plastic and alloy, may be used to form the outer layer 10ai.

The driving mechanism 20i includes a driving module 22i and a first driving rod 24i. The first driving rod 24i includes a first end 24ai and a second end 24bi opposite to the first end 24ai. The first end 24ai is connected to the driving module 22i, and the second end 24bi is connected to the massage portion 30i. Under the action of driving module 22i, the massage portion 30i rotates along with the second end 24bi around the first end 24ai, forming an annular trajectory, which can generate a kneading effect on the human body.

In this embodiment, A first vibration component 41i, such as a vibration motor, is provided inside the massage portion 30i. A second vibrating component 42i, such as a vibration motor, is provided inside the massage end 32i. A third vibrating component 43i, such as another vibration motor, is provided inside the branch 18i. The holding end is equipped with buttons 54i to control the operation of the driving module 22i, the first vibrating component 41i, the second vibrating component 42i, the third vibrating component 43i, and etc. When this sexual stimulation device is in use, the massage portion 30i, the massage end 32i, and the branch 18i may respectively act on three different parts of the human body, for example, the massage end 32i may be used to stimulate the vagina, the massage portion 30i may be used to stimulate the crus of clitoris, and the branch 18i may be used to stimulate the glans of clitoris, further improving the stimulation effect. In an alternatively embodiment, one of the massage portion 30i, the massage end 32i and the branch 18i has a vibrating component disposed therein, or two of the massage portion 30i, the massage end 32i and the branch 18i each has a vibrating component disposed therein.

Finally, it should be noted that: the above merely describes preferred embodiments of the present application without intention to limit the scope of the present application. Although the present application has been described in detail with reference to the foregoing embodiments, for those skilled in the art, the technical solutions described in the foregoing embodiments can still be modified, or some of the technical features can be equally replaced. Any modifications, equivalent replacements, improvements, and etc. made within the spirit and principle of the present application should be within the scope of the present application.

What is claimed is:

1. A massage device, comprising:
a shell comprising a first section, a second section, and a third section connected one after another with the second section being connected between the first section and the third section, and the third section being configured as a main massage portion to be inserted into human body in an insertion direction;
a driving mechanism disposed in the shell; and
a branch massage portion connected to the shell, the branch massage portion being connected to the driving mechanism in a transmission manner, wherein the driving mechanism is configured to drive the branch massage portion to rotate around a rotation axis;
wherein the branch massage portion extends in the insertion direction or in a direction opposite to the insertion direction.

2. The massage device according to claim 1, wherein, the shell defines a recess portion, the first section, the second section and the third section cooperatively define the recess portion, and the branch massage portion extends into the recess portion.

3. The massage device according to claim 1, wherein the shell of at least one of the first section, the second section, or the third section comprises an outer layer and an inner layer, the inner layer is covered by the outer layer, and the outer layer is a soft layer.

4. The massage device according to claim 2, wherein a maximum cross-sectional area of the first section and a maximum cross-sectional area the third section are both larger than a maximum cross-sectional area of the second section, thereby forming the recess portion at one side of the second section.

5. The massage device according to claim 2, wherein the driving mechanism is disposed in an inner cavity of the first section, the branch massage portion is arranged on a side wall of the first section that forms the recess portion, and the branch massage portion is connected to the driving mechanism in a transmission manner.

6. The massage device according to claim 2, wherein the driving mechanism is disposed in an inner cavity of the third section, the branch massage portion is arranged on a side wall of the third section that forms the recess portion, and the branch massage portion is connected to the driving mechanism in a transmission manner.

7. The massage device according to claim 6, wherein a distal end of the branch massage portion and an end of the third section away from the second section are connected by a connecting portion, and the connecting portion is made of soft material.

8. The massage device according to claim 2, wherein the driving mechanism comprises a driving motor and a drive shaft, the drive shaft comprises a first shaft body and a second shaft body connected to each other, wherein an end of the first shaft body away from the second shaft body is connected to a motor shaft of the driving motor, at least an end of the second shaft body away from the first shaft body extends into the recess portion, the second shaft body is connected to the branch massage portion in a transmission manner, and the driving motor drives the second shaft body to rotate around the rotation axis, with a longitudinal axis of the second shaft body being at an angle with respect to the rotation axis.

9. The massage device according to claim 8, wherein the branch massage portion comprises a massage housing connected to the second shaft body.

10. The massage device according to claim 9, wherein the branch massage portion further comprises a flexible sleeve covering an exterior of the massage housing.

11. The massage device according to claim 8, wherein the branch massage portion further comprises a first vibration motor installed inside the massage housing;
the massage device further comprises a second vibration motor installed in an inner cavity of the third section to drive the third section to move;
the first section and the second section are arranged at an angle, with the first section inclined towards the branch massage portion, a protrusion is formed on a side of the first section facing the branch massage portion, and a third vibration motor is installed in the first section.

12. The massage device according to claim 11, wherein an angle between the first section and the second section is an acute angle, such that the first section and the second section substantially form an L-shape.

13. The massage device according to claim 11, wherein the massage device further comprises a control board and a battery installed in the inner cavity of the first section, the control board is electrically connected to the battery, and the control board is electrically connected to the driving motor, the first vibration motor, the second vibration motor, and the third vibration motor.

14. The massage device according to claim 1, wherein the branch massage portion is elongated.

15. The massage device according to claim 1, wherein a maximum cross-sectional area of the third section is larger than that of the branch massage portion.

16. A massage device, comprising:
a shell comprising a first section, a second section, and a third section connected each other, the second section being connected between the first section and the third section;
a driving mechanism disposed in the shell; and
a branch massage portion connected to the driving mechanism in a transmission manner, wherein the driving mechanism is configured to drive the branch massage portion to rotate;
wherein the branch massage portion is elongated and extends at least partially along a lateral side of the shell with a gap defined between the branch massage portion and the lateral side of the shell.

17. The massage device according to claim 16, wherein the driving mechanism comprises a driving motor and a drive shaft, the drive shaft comprises a first shaft body and a second shaft body connected to each other, wherein an end of the first shaft body away from the second shaft body is connected to a motor shaft of the driving motor, at least an end of the second shaft body away from the first shaft body extends into the recess portion, the second shaft body is connected to the branch massage portion in a transmission manner, and the driving motor drives the second shaft body to rotate around the rotation axis, with a longitudinal axis of the second shaft body being at an angle with respect to the rotation axis.

18. The massage device according to claim 16, wherein the shell defines a recess portion, the first section, the second section and the third section cooperatively define the recess portion, and the branch massage portion extends into the recess portion.

19. The massage device according to claim 16, wherein the driving mechanism is disposed in an inner cavity of the first section, the branch massage portion is arranged on a side wall of the first section that forms the recess portion, and the branch massage portion is connected to the driving mechanism in a transmission manner.

20. The massage device according to claim 16, wherein the driving mechanism is disposed in an inner cavity of the third section, the branch massage portion is arranged on a side wall of the third section that forms the recess portion, and the branch massage portion is connected to the driving mechanism in a transmission manner.
